(19) United States
(12) Patent Application Publication
(10) Pub. No.: US 2025/0208990 A1
(43) Pub. Date: Jun. 26, 2025

(54) SMART COLUMN ADDRESS STROBE (CAS) BURST CONTINUATION

(71) Applicant: Advanced Micro Devices, Inc., Santa Clara, CA (US)

(72) Inventors: Tahsin Askar, Austin, TX (US); James R. Magro, Lakeway, TX (US)

(73) Assignee: Advanced Micro Devices, Inc., Santa Clara, CA (US)

(21) Appl. No.: 18/392,707

(22) Filed: Dec. 21, 2023

(51) Int. Cl. G06F 12/02

(52) U.S. Cl. CPC G06F 12/023

(57) ABSTRACT

A data processing system includes a data processor and a memory. The data processor is for issuing memory commands including a first memory command that accesses data of a first size. The memory is operative to transfer data of the first size by separating a first portion of data from a second portion of data by a data gap. The data processor is operable to selectively prioritize and issue a second memory command after issuing the first memory command at a time that fills the data gap.

### BACKGROUND

Modern microprocessors and systems-on-chip (SoCs) are designed for the specific operating environments in which they will be used. For example, typical microprocessors for high-end computing and server applications have many central processing unit (CPU) cores on chip with deep cache hierarchies and multiple memory controllers to multiple memory channels. On the other hand, typical microprocessors for personal computing combine multiple CPU cores with a graphics processing unit (GPU) or GPU core complex, providing high performance with higher levels of integration and lower cost for desktop computing and notebook applications. Microprocessors that combine CPUs and GPUs are sometimes referred to as accelerated processing units, or APUs.

APUs typically use what is known as a unified memory architecture in which the CPU cores and GPU or GPU core complex share a memory space that is accessed by one or more common memory controllers. A problem arises with memory bandwidth and efficiency because CPU cores and GPU cores or GPU core complexes have different natural data widths between CPU cache lines on the one hand and GPU graphics objects on the other. Because of this disparity, memory standards such as various double data rate (DDR) DRAM standards promulgated by the Joint Electron Devices Engineering Council (JEDEC) allow the selection of a memory access burst lengths “on-the-fly” so the optimal size can be adjusted during operation, in which a burst length is a number of data transfer cycles performed in response to a single memory command. For example, low-power DDR, version five (LPDDR5) DRAMs support burst lengths of both 16 and 32 and can select them on-the-fly through command encoding.

Because DDR memories have highly pipelined internal architectures, they require long latencies between the time a command is received and the time the data is transferred. These architectures create “gaps” in the data transfers when the larger burst length size is chosen such that a first portion of the data of the longer access is transferred on the bus but is separated in time from the second portion of the data by a data gap. The gaps can be filled if other accesses are issued at the right time. However, APU memory controllers also must meet other requirements to achieve high data bus efficiency such reducing turnarounds between writes and reads and prioritizing accesses to open pages. These other factors reduce the practical ability of command interleaving to fill the gaps adequately and consistently, limiting data bus efficiency.

### BRIEF DESCRIPTION OF THE DRAWINGS

FIG. 1 illustrates in block diagram form a data processing system according to some implementations;

FIG. 2 illustrates in block diagram form a memory controller suitable for use in an APU like that of FIG. 1 according to some implementations;

FIG. 3 illustrates in block diagram form a memory access circuit useful in understanding the present disclosure;

FIG. 4 illustrates a timing diagram illustrating filling of a data gap according to some implementations;

FIG. 5 illustrates in block diagram form a command queue entry suitable to use in the memory controller of FIG. 2 according to some implementations; and

FIG. 6 is a flow chart illustrating a process of performing refresh during a power state change according to some implementations.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate implementations using suitable forms of indirect electrical connection as well. The following Detailed Description is directed to electronic circuitry, and the description of a block shown in a drawing figure implies the implementation of the described function using suitable electronic circuitry, unless otherwise noted.

### DETAILED DESCRIPTION

A data processing system includes a data processor and a memory. The data processor is for issuing memory commands including a first memory command that accesses data of a first size. The memory is operative to transfer data of the first size by separating a first portion of data from a second portion of data by a data gap. The data processor is operable to selectively prioritize and issue a second memory command after issuing the first memory command at a time that fills the data gap.

A data processor includes a first memory accessing agent capable of generating a first memory access request of a first size, and a memory controller. The memory controller includes a command queue for storing a plurality of memory access requests, and an arbiter for selecting accesses from the command queue according to a plurality of arbitration rules. The memory controller is operative to prioritize and issue a first memory command of the first size to a memory that is operative to transfer data of the first size by separating a first portion of data from a second portion of data by a data gap. The memory controller is further operative to selectively issue a second memory command after issuing the first memory command at a time that fills the data gap.

A method includes generating a first memory access request that accesses data of a first size by a first memory accessing agent. A first memory command is issued in response to the first memory access request to a memory that transfers data of the first size by separating a first portion of data from a second portion of data by a data gap. A second memory command is selectively prioritized and issued after issuing the first memory command at a time that fills the data gap.

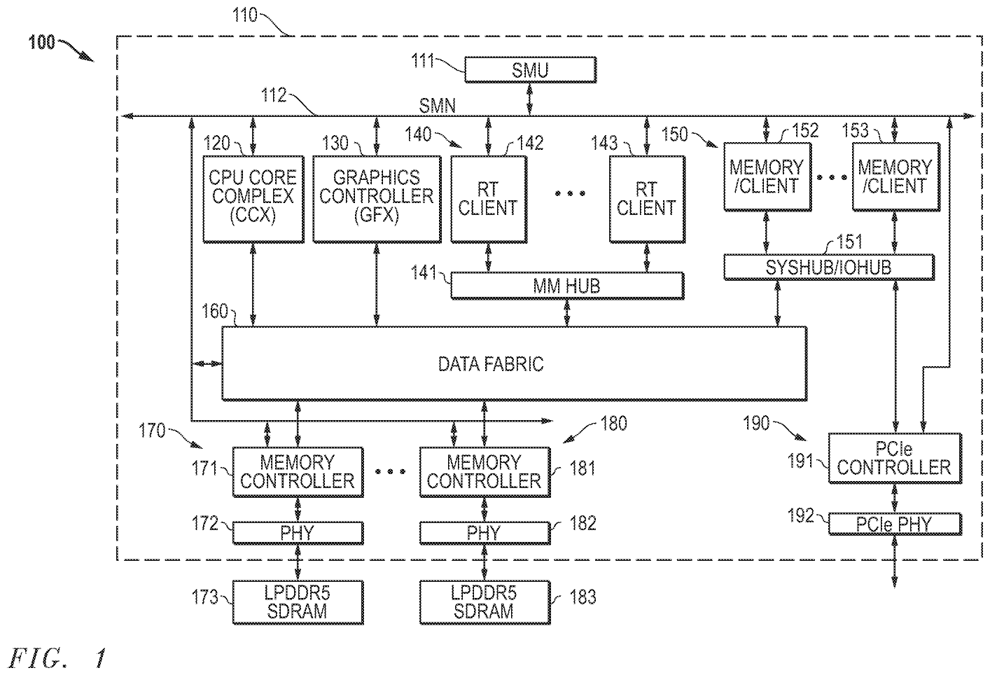

FIG. 1 illustrates in block diagram form a data processing system 100 according to some implementations. Data processing system 100 includes a data processor 110 in the form of an APU and memory in the form of low-power Double Data Rate, version 5, synchronous dynamic random-access memory (LPDDR5 SDRAMs) including an LPDDR5 memory 173 and an LPDDR5 memory 183. Many other components of an actual data processing system are typically present but are not relevant to understanding the present disclosure and are not shown in FIG. 1 for ease of illustration.

Data processor 110 includes generally a system management unit (SMU) 111, a system management network (SMN) 112, a central processing unit (CPU) core complex 120 labeled “CCX”, a graphics controller 130 labeled “GFX”, a real-time client subsystem 140, a memory/client subsystem 150, a data fabric 160, memory channels 170 and 180, and a Peripheral Component Interface Express (PCIe) subsystem 190. As will be appreciated by a person of ordinary skill, data processor 110 may not have all of these elements present in every implementation and, further, may have additional elements included therein.

SMU 111 is bidirectionally connected to the major components in data processor 110 over SMN 112. SMN 112 forms a control fabric for data processor 110. SMU 111 is a local controller that controls the operation of the resources on data processor 110 and synchronizes communication among them. SMU 111 manages power-up sequencing of the various processors on data processor 110 and controls multiple off-chip devices via reset, enable and other signals. SMU 111 includes one or more clock sources (not shown), such as a phase locked loop (PLL), to provide clock signals for each of the components of data processor 110. SMU 111 also manages power for the various processors and other functional blocks, and may receive measured power consumption values from CPU cores in CPU core complex 120 and graphics controller 130 to determine appropriate P-states.

CPU core complex 120 includes a set of CPU cores, each of which is bidirectionally connected to SMU 111 over SMN 112. Each CPU core may be a unitary core only sharing a last-level cache with the other CPU cores, or may be combined with some but not all of the other cores in clusters.

Graphics controller 130 is bidirectionally connected to SMU 111 over SMN 112. Graphics controller 130 is a high-performance graphics processing unit capable of performing graphics operations such as vertex processing, fragment processing, shading, texture blending, and the like in a highly integrated and parallel fashion. In order to perform its operations, graphics controller 130 requires periodic access to external memory. In the implementation shown in FIG. 1, graphics controller 130 shares a common memory subsystem with CPU cores in CPU core complex 120, an architecture known as a unified memory architecture. Because data processor 110 includes both a CPU and a GPU, it is also referred to as an accelerated processing unit (APU).

Real-time client subsystem 140 includes a set of real-time clients such as representative real time clients 142 and 143, and a memory management hub 141 labeled “MM HUB”. Each real-time client is bidirectionally connected to SMU 111 over SMN 112, and to memory management hub 141. Real-time clients 140 could be any type of peripheral controller that requires periodic movement of data, such as an image signal processor (ISP), an audio coder-decoder (codec), a display controller that renders and rasterizes objects generated by graphics controller 130 for display on a monitor, and the like.

Memory/client subsystem 150 includes a set of memory elements or peripheral controllers such as representative memory/client devices 152 and 153, and a system and input/output hub 151 labeled “SYSHUB/IOHUB”. Each memory/client device is bidirectionally connected to SMU 111 over SMN 112, and to system and input/output hub 151. Memory/client devices are circuits that either store data or require access to data on an aperiodic fashion, such as a non-volatile memory, a static random-access memory (SRAM), an external disk controller such as a Serial Advanced Technology Attachment (SATA) interface controller, a universal serial bus (USB) controller, a system management hub, and the like.

Data fabric 160 is an interconnect that controls the flow of traffic in data processor 110. Data fabric 160 is bidirectionally connected to SMU 111 over SMN 112, and is bidirectionally connected to CPU core complex 120, graphics controller 130, memory management hub 141, system and input/output hub 151. Data fabric 160 includes a crossbar switch for routing memory-mapped access requests and responses between any of the various devices of data processor 110. It includes a system memory map, defined by a basic input/output system (BIOS), for determining destinations of memory accesses based on the system configuration, as well as buffers for each virtual connection.

Memory channels 170 and 180 are circuits that control the transfer of data to and from LPDDR5 memory 173 and LPDDR5 memory 183. Memory channel 170 is formed by a memory controller 171 and a physical interface circuit 172 labeled “PHY” connected to LPDDR5 memory 173. Memory controller 171 is bidirectionally connected to SMU 111 over SMN 112 and has an upstream port bidirectionally connected to data fabric 160, and a downstream port. Physical interface circuit 172 has an upstream port bidirectionally connected to memory controller 171, and a downstream port bidirectionally connected to LPDDR5 memory 173. Similarly, memory channel 180 is formed by a memory controller 181 and a physical interface circuit 182 connected to LPDDR5 memory 183. Memory controller 181 is bidirectionally connected to SMU 111 over SMN 112 and has an upstream port bidirectionally connected to data fabric 160, and a downstream port. Physical interface circuit 182 has an upstream port bidirectionally connected to memory controller 181, and a downstream port bidirectionally connected to LPDDR5 memory 183.

Peripheral Component Interface Express (PCIe) subsystem 190 includes a PCIe controller 191 and a PCIe physical interface circuit 192. PCIe controller 191 is bidirectionally connected to SMU 111 over SMN 112 and has an upstream port bidirectionally connected to system and input/output hub 151, and a downstream port. PCIe physical interface circuit 192 has an upstream port bidirectionally connected to PCIe controller 191, and a downstream port bidirectionally connected to a PCIe fabric, not shown in FIG. 1. PCIe controller is capable of forming a PCIe root complex of a PCIe system for connection to a PCIe network including PCIe switches, routers, and devices.

In operation, data processor 110 integrates a complex assortment of computing and storage devices, including CPU core complex 120 and graphics controller 130, on a single chip. Most of the features of these controllers are well known and will not be discussed further. However, each CPU in CPU core complex 120 has a cache hierarchy in which individual cache lines have a native width. Since the cache hierarchy stores valid cache lines on a line-by-line basis, when a CPU in CPU core complex 120 receives a memory load or store instruction, the cache typically allocates the full cache line to its internal cache. A typical CPU cache line is 64 bytes/512 bits. LPDDR5 memory 173 and LPDDR5 memory 183 support a command known as “READ32” in which a by-16 (×16) memory performs the cache line fill or writeback operation using two 16-beat bursts (2×16×16=64 bytes/512 bits) separated by a data gap. The data gap reduces the efficiency of the usage of the data bus compared to a series of consecutive 16-beat bursts (32-byte accesses), either reads or writes.

As will be described in greater detail below, implementations of a data processing system such as data processing system 100, a data processor such as data processor 110, and a corresponding method reduce the loss of efficiency by implementing a “smart CAS burst continuation” feather. Using this feature, they intelligently “fill the gaps” and continue the uninterrupted usage of the data bus during a burst of CAS accesses. They do so by prioritizing and issuing commands that fill the data gaps in preference to commands that do not fill the data gaps.

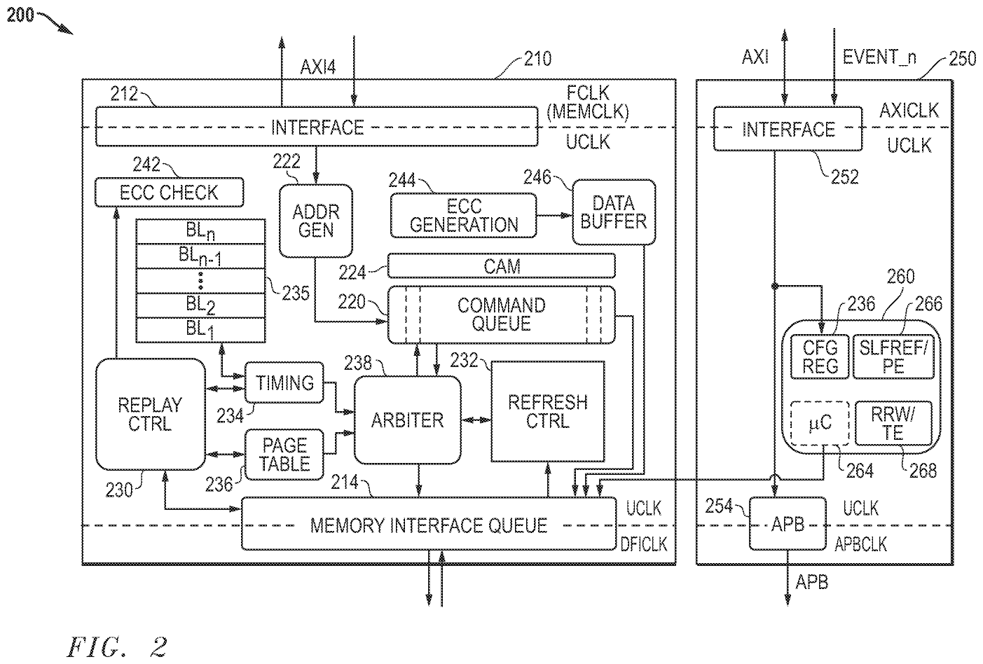

FIG. 2 illustrates in block diagram form a memory controller 200 that is suitable for use in an APU like that of FIG. 1. Memory controller 200 includes generally a memory channel controller 210 and a power controller 250. Memory channel controller 210 includes generally an interface 212, a memory interface queue 214, a command queue 220, an address generator 222, a content addressable memory (CAM) 224, a replay control circuit 230, a refresh control logic 232, a timing block 234, a burst length history table 235, a page table 236, an arbiter 238, an error correction code (ECC) check circuit 242, an ECC generation block 244, a data buffer 246, and refresh logic 247.

Interface 212 has a first bidirectional connection to data fabric 125 over an external bus, and has an output. In memory controller 200, this external bus may be compatible with the advanced extensible interface version four bus specification, known as “AXI4”, but can be other types of interfaces in other implementations. Interface 212 translates memory access requests from a first clock domain known as the FCLK (or MEMCLK) domain to a second clock domain internal to memory controller 200 known as the UCLK domain. Similarly, memory interface queue 214 provides memory accesses from the UCLK domain to a DFICLK domain associated with the DFI interface.

Address generator 222 decodes addresses of memory access requests received from data fabric 125 over the AXI4 bus. The memory access requests include access addresses in the physical address space represented in a normalized format. Address generator 222 converts the normalized addresses into a format that can be used to address the actual memory devices in the memory system, as well as to efficiently schedule related accesses. This format includes a region identifier that associates the memory access request with a particular rank, a row address, a column address, a bank address, and a bank group. On startup, the system BIOS queries the memory devices in the memory system to determine their size and configuration, and programs a set of configuration registers associated with address generator 222. Address generator 222 uses the configuration stored in the configuration registers to translate the normalized addresses into the appropriate format.

Command queue 220 is a queue of memory access requests received from the memory accessing agents in data processing system 100, such as CPU core complex 120 and graphics controller 130, in which a memory accessing agent is a circuit capable of generating memory access requests. Command queue 220 stores the address fields decoded by address generator 222 as well other address information that allows arbiter 238 to select memory accesses efficiently, including access type and quality of service (QOS) identifiers. Command queue 220 also stores metadata about the request, such as whether the entry has achieved timing eligibility based on timing parameters associated with the operation of the memory. Content addressable memory 224 includes information to enforce ordering rules, such as write after write (WAW) and read after write (RAW) ordering rules.

Error correction code (ECC) generation block 244 determines the ECC of write data to be sent to the memory. ECC check circuit 242 checks the received ECC against the incoming ECC.

Replay control circuit 230 allows the replay of issued commands in which an error is indicated. It includes a temporary queue for storing selected memory accesses picked by arbiter 238 that are awaiting responses, such as address and command parity responses, and replay control logic that accesses ECC check circuit 242 to determine whether the returned ECC is correct or indicates an error. The replay control logic initiates and controls a replay sequence in which accesses are replayed in the case of a parity or ECC error of one of these cycles. Replayed commands are placed in memory interface queue 214.

Refresh control logic 232 includes state machines for various power down, refresh, and termination resistance (ZQ) calibration cycles that are generated separately from normal read and write memory access requests received from memory accessing agents. For example, if a memory rank is in precharge power down, it must be periodically awakened to run refresh cycles. Refresh control logic 232 generates refresh commands periodically and in response to designated conditions to prevent data errors caused by leaking of charge off storage capacitors of memory cells in DRAM chips. Refresh control logic 232 includes an activate counter 248, which in this implementation has a counter for each memory region which counts a rolling number of activate commands sent over the memory channel to a memory region. The memory regions are memory banks in some implementations, and memory sub-banks in other implementations as further discussed below. In addition, refresh control logic 232 periodically calibrates ZQ to prevent mismatch in on-die termination resistance due to thermal changes in the system.

Timing block 234 maintains a set of counters that determine eligibility based on timing parameters specified in the JEDEC specification, and is bidirectionally connected to replay control circuit 230. Timing block 234 is further connected to burst length history table 235 to allow it to determine whether certain accesses have created gaps in the data bus, e.g., by LPDDR5 reads of burst length 32.

As will be described further below, memory controller 200 implements the Smart CAS burst continuation feature. Arbiter 238 is aware of these data gaps and selectively prioritizes and issues memory commands that fill the data gaps in preference to memory commands that do not fill the data gaps. In response to the burst length history and the command latency, arbiter 238 is operative to selectively prioritize and issue to memory interface queue 214 memory commands that fill the data gaps based on the timing of issuance of commands as indicated by the history.

The Smart CAS feature exists with other arbitration mechanisms to make commands that fill the gaps eligible earlier. For example, a read page miss command is a read operation to a closed page in a memory bank that is in the precharged state. Before the read command can be sent to the LPDDR5 memory, the page has to be opened using an ACT command. After arbiter 238 dispatches the ACT command, an actual read command can be sent sooner without using bandwidth for the ACT command and interrupting the CAS burst. In response to sending the ACT command, arbiter 238 marks the corresponding page as active in page table 236, and the corresponding read command will become timing eligible as soon as t_{RCD} has been met.

A read page conflict command is a read operation to a closed page in particular memory bank that has a different page open. Before the read command can be sent to the LPDDR5 memory, the currently open page must be closed with a precharge PRE command to that bank. Afterward, the new page is opened using an ACT command. After it dispatches the PRE command, arbiter 238 clears the entry in page table 236 for the corresponding page to indicate that no page is open. Then arbiter 238 sends the ACT command in the next suitable command slot. The actual read command can be sent sooner and not use bandwidth later on the command bus as described above.

Page table 236 maintains state information about active pages in each bank and rank of the memory channel for arbiter 238, and is bidirectionally connected to replay control circuit 230.

Arbiter 238 is bidirectionally connected to command queue 220 and is the heart of memory channel controller 210, and improves efficiency by intelligent scheduling of accesses to improve the usage of the memory bus. Arbiter 238 uses timing block 234 to enforce proper timing relationships by determining whether certain accesses in command queue 220 are eligible for issuance based on DRAM timing parameters. For example, each DRAM has a minimum specified time between activate commands, known as “t_{RRD}”.

In response to write memory access requests received from interface 212, ECC generation block 244 computes an ECC according to the write data. Data buffer 246 stores the write data and ECC for received memory access requests. It outputs the combined write data/ECC to memory interface queue 214 when arbiter 238 picks the corresponding write access for dispatch to the memory channel.

Power controller 250 generally includes an interface 252 to an advanced extensible interface, version one (AXI), an advanced peripheral bus (APB) interface 254, and a power engine 260. Interface 252 has a first bidirectional connection to the SMN, which includes an input for receiving an event signal labeled “EVENT_n” shown separately in FIG. 2, and an output. APB interface 254 has an input connected to the output of interface 252, and an output for connection to a physical interface circuit over an APB. Power engine 260 has an input connected to the output of interface 252, and an output connected to an input of memory interface queue 214. Power engine 260 includes a set of configuration registers 262, a microcontroller (μC) 264, a self-refresh controller 266 labelled “SLFREF/PE”, and a reliable read/write timing engine 268 labelled “RRW/TE”. Configuration registers 262 are programmed over the AXI bus, and store configuration information to control the operation of various blocks in memory controller 200. Accordingly, configuration registers 262 have outputs connected to these blocks that are not shown in detail in FIG. 2. SLFREF/PE 266 is an engine that allows the manual generation of refreshes in addition to the automatic generation of refreshes by refresh control logic 232. Reliable read/write timing engine 268 provides a continuous memory access stream to memory or I/O devices for such purposes as DDR interface maximum read latency (MRL) training and loopback testing.

Memory channel controller 210 includes circuitry that allows it to pick memory accesses for dispatch to the associated memory channel. In order to make the desired arbitration decisions, address generator 222 decodes the address information into predecoded information including rank, row address, column address, bank address, and bank group in the memory system, and command queue 220 stores the predecoded information. Configuration registers 262 store configuration information to determine how address generator 222 decodes the received address information. Arbiter 238 uses the decoded address information, timing eligibility information indicated by timing block 234, and active page information indicated by page table 236 to efficiently schedule memory accesses while observing other criteria such as quality of service (QOS) requirements that exist along with the Smart CAS burst continuation feature. For example, arbiter 238 implements a preference for accesses to open pages to avoid the overhead of precharge and activation commands required to change memory pages, and hides overhead accesses to one bank by interleaving them with read and write accesses to another bank. In particular during normal operation, arbiter 238 normally keeps pages open in different banks until they are required to be precharged prior to selecting a different page. Arbiter 238, in some implementations, determines eligibility for command selection based at least on respective values of activate counter 248 for target memory regions of the respective commands.

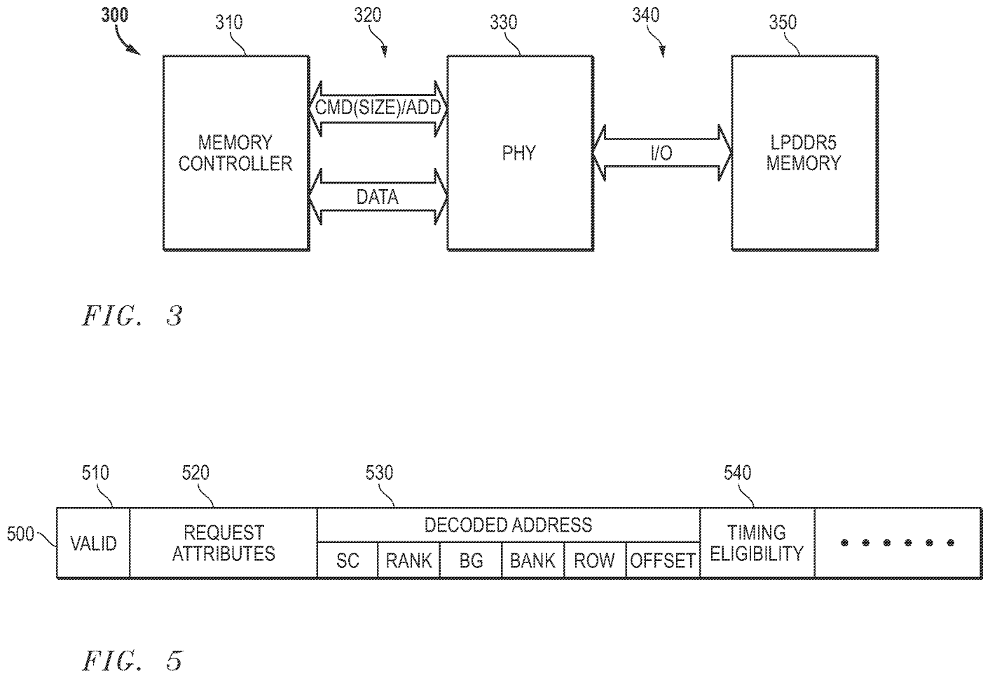

FIG. 3 illustrates in block diagram form a memory access circuit 300 useful in understanding the present disclosure. Memory access circuit 300 includes generally a memory controller 310, a bus 320, a physical interface circuit 330 labeled “PHY”, a bus 340, and an LPDDR5 memory 350. Memory controller 310 has an input (not shown) for receiving memory access requests, and is connected to bus 320.

Bus 320 is implemented as a DDR-to-PHY bus according to the DFI specification. The DFI specification defines certain signals and signal groups that allow memory controller 310 to inter-operate with physical interface circuits from different manufacturers. As shown in memory access circuit 300, these signals include a set of command and address signals that encode a size of the transfer, and a bidirectional data bus.

Physical interface circuit 330 conducts input/output signals labelled “I/O” between physical interface circuit 330 and LPDDR5 memory 350. By translating a standard set of DFI signals into signals used by LPDDR5 memory 350, physical interface circuit 330 allows memory controller 310 to abstract the memory present in the system to memory controller 310. It also allows a vendor to design a physical interface circuit as a hard macrocell that is usable in and adapted for the selected process technology node and capable of reliable operation at high speeds.

Bus 340 is a high-speed bus whose signals and timing are described by the LPDDR5 standard.

LPDDR5 memory 350 includes one or more ranks of one or more LPDDR5 SDRAM chips. While the techniques disclosed herein are applied to an LPDDR5 system, other current and future memory technologies can be used in other implementations.

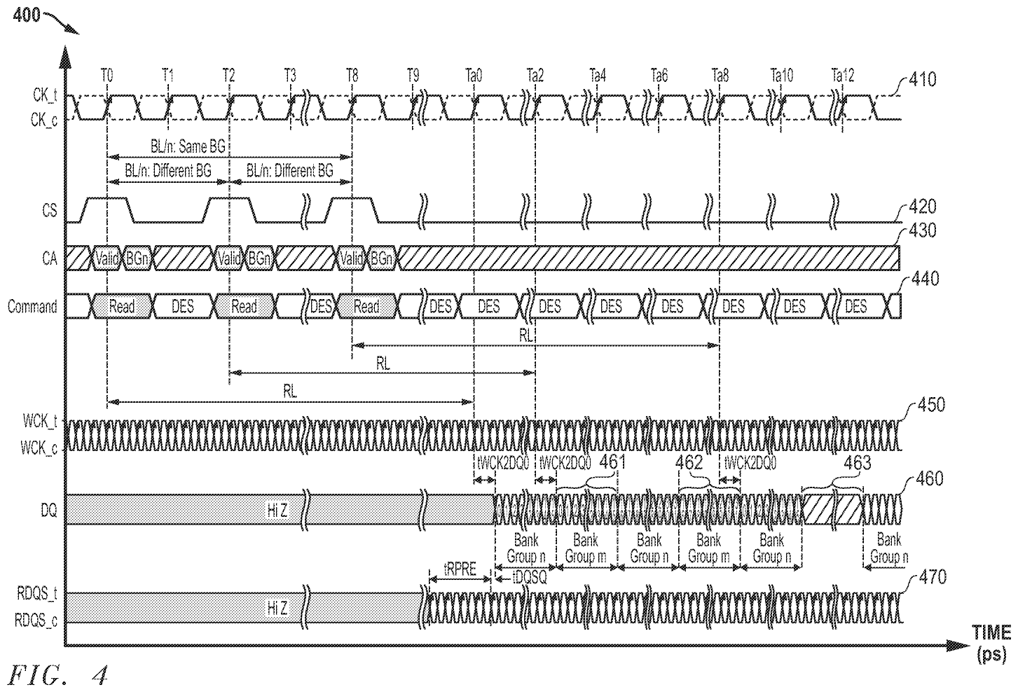

FIG. 4 illustrates a timing diagram 400 illustrating data gaps. In FIG. 4, the horizontal axis represents time in picoseconds (ps), and the vertical axis represents the states of various signals. Shown in timing diagram 400 are waveforms of various signal groups of interest, and various time points of interest labelled “T0”, “T1”, and so on.

A waveform 410 represents a differential clock signal provided from physical interface circuit 330 to LPDDR5 memory 350 formed by a true clock signal labelled “CK_t”, and a complementary clock signal labelled “CK_c” and designated collectively as “CK”. LPDDR5 memory 350 uses low-to-high transitions of the CK_t signal and high-to-low transitions of the CK_c signal on which to capture commands. Shown in timing diagram 400 are a first set of CK signals labelled “T0” through “T9”, and a second set of CK signals labelled “Ta0” through “Ta12”, with some transitions that continue prior patterns occurring during certain intervals omitted in timing diagram 400.

A waveform 420 represents a chip select signal labelled “CS”. The CS signal validates commands sent from the physical interface circuit to the memory. In timing diagram 400, the commands include a command at T0, a command at T2, and a command at T8

A waveform 430 represents a set of command and address input signals labelled “CA” that are provided from physical interface circuit 330 to LPDDR5 memory 350. A waveform 440 is an abstraction of the commands on the CA signals that identify the type of command and its memory address. Considering waveforms 430 and 440 together, physical interface circuit 330 sends a read command at T0 that is registered as a valid command on the CA signals at T0 and is followed by a second cycle that registers the address including the bank group of a bank group n labelled “BGn” on the CA signals in the T0 cycle. In this example, the command is a READ command of burst length 32 that the memory will split into two portions with a data gap. The READ command at T0 is followed by a deselect (DES) command at T1 in order to satisfy the minimum command-to-command delay time when the commands are to different bank groups. physical interface circuit 330 sends a read command to a different bank group m, labelled “BGm”, at T2. Memory controller 310 and physical interface circuit 330 cannot send the next command to bank group BGn of the memory until time T8 to allow the second halves of the requested data for the first two commands to be sent. Timing diagram 400 shows only DES cycles after T8.

A waveform 450 represents a differential write clock input signal provided from physical interface circuit 330 to LPDDR5 memory 350 formed by a true write clock signal labelled “WCK_t”, and a complementary write clock signal labelled “WCK_c”, and designated collectively as the WCK signal. A waveform 470 represents a differential read clock input signal provided from LPDDR5 memory 350 to physical interface circuit 330 and formed by a true read clock signal labelled “RCK_t”, and a complementary read clock signal labelled “RCK_c”, and designated collectively as the WCK signal. The WCK and RCK signals are similar except the RCK signal is gated off except during and immediately before and after read cycles. As shown in timing diagram 400, both the WCK signal and the RCK signal have twice the frequency of the CK signal. Timing diagram 400 shows operation in a so-called 4:1 mode, because there are four data transfers for every cycle of the CK signal, in which the WCK signal and the RCK signal have twice the frequency of the main clock signal CK, and data is transferred on every clock edge according to the double data rate technique.

A waveform 460 represents a bidirectional data signal labelled “DQ” and a data mask/inversion signal labelled “DMI”. During the series of read cycles that occur as part of the READ command registered in the memory at time T0, the memory provides, after a read latency period labelled “RL” and a write clock to data out delay labelled “tWCK2DQO”, the requested data. As shown in timing diagram 400, responsive to a burst length of 32, the LPDDR5 memory outputs the first sixteen data elements labelled “0” to “15” a delay time tDQSQ after transitions of the RCK signal, followed by a data gap in a time period 461, and continuing with the second sixteen data elements labelled “16” to 31″ to complete the read command of burst length 32. In the example shown by timing diagram 400, memory controller 310 is able to fill the data gap of time period 461 by sending a second read command to a different bank group, BGm, a read latency RL before the data gap occurs. Since the second read command also has a burst length of 32, it fills a subsequent data gap in time period 462 if the memory controller has additional read commands to BGn available for issue.

As shown in timing diagram 400, however, there are no additional commands available for issue after the transmission of the first half of the second BGn command, causing the data bus to remain idle during a gap 463 and resulting in inefficiency in usage of the data bus.

There are various situations in which a data gap cannot be filled while there are commands remaining in the command queue. For example, there can be commands in the command queue but of a different type, such as write commands that are ineligible during a streak of read commands, or read commands that are ineligible during a streak of write commands. There may be other commands that are not yet eligible because other timing requirements have not been met. There may also be commands of the same type, i.e., reads during a read streak or writes during a write streak, which have a shorter burst length and thus will not completely fill the gaps. As shown in timing diagram 400, the READ command to BGm received at time T2 is able to completely fill the gap because it has a burst length of 32, while a command of burst length 16 would have left a data gap during time period 462. Moreover, there may be commands of the same type to a different bank group that are not yet ready, such as commands to a closed page, requiring the current page to be closed and the new page to be opened with appropriate delays before it becomes timing eligible.

According to various implementations disclosed herein, memory controller 310 considers the data gap in deciding when to issue various commands. In this way, memory controller 310 decreases the occurrence of unfilled data gaps and improves the efficiency in utilization of the data bus. Memory controller 310 is operative to selectively prioritize and issue a command that fills the data gap created by an earlier memory command, in preference to another command that does not fill the data gap. It does so, for example, in conjunction with various other conventional arbitration rules and eligibility requirements noted above.

In one example, arbiter 238 may issue a command that fills a data gap in preference to issuing an access to an open page. This preference may cause arbiter 238 to issue an earlier access to an open page with an auto-precharge attribute to close the page and to allow a newer command to fill a data gap. In another example, arbiter 238 may issue a newer command that has a burst length of 32 that completely fills the data gap in preference to an older command that does not fill the data gap completely. In some implementations, arbiter 238 uses burst length history table 235 to prioritize the second memory command in preference to a third memory command in response to the history of burst lengths kept in burst length history table 235.

FIG. 5 illustrates in block diagram form a command queue entry 500 suitable to use in memory controller 200 of FIG. 2 according to some implementations. Command queue entry has a valid field 510, a request attributes field 520, a decoded address field 530, a timing eligibility field 540, and other fields whose size and purpose are not relevant to understanding the current implementations. Each sub-field may include one or more bits according to its respective function. Valid field 510 indicates whether command queue entry 500 is valid or not. Request attributes field 520 include information about the type of access, e.g., read or write, the size of the request, e.g., 32 bytes or 64 bytes, the quality of service (QOS) of the request, a tag indicating a relative age of the request, and potentially other fields. Decoded address field 530 maps the address of the memory access request to addresses of memory devices actually present in the data processing system. As shown in FIG. 5, they include a sub-channel field labelled “SC”, a rank field labelled “RANK” a bank group field labelled “BG”, a bank field labelled “BANK”, a row field labelled “ROW”, and an offset field labelled “OFFSET”. Usage of the sub-channel field and the bank group field depends on the type of memory supported. Timing eligibility field 540 includes one or more bits that indicate whether the memory access request is ready to be issued to the memory system by meeting all required minimum timing constraints.

According to various implementations, when there is a data gap caused by, for example, a READ32 command, arbiter 238 selectively prioritizes and issues commands that fill the data gap. For example, with all other things equal, arbiter 238 has a preference for issuing older memory access requests before issuing newer memory access requests. However, if a given memory access request that fills the data gap is newer than another memory access request that does not fill the data gap, arbiter 238 may prioritize and issue the newer memory access request in preference to the older memory access request to fill the data gap. When operating with the exemplary LPDDR5 memory, a command that can fill the data gap needs to access a different bank group than the command that created the data gap, and arbiter 238 considers the bank group indicated by the BG field in making the arbitration decision after issuance of the command that created the data gap. In this way, the Smart CAS burst continuation mechanism improves data bus utilization and efficiency.

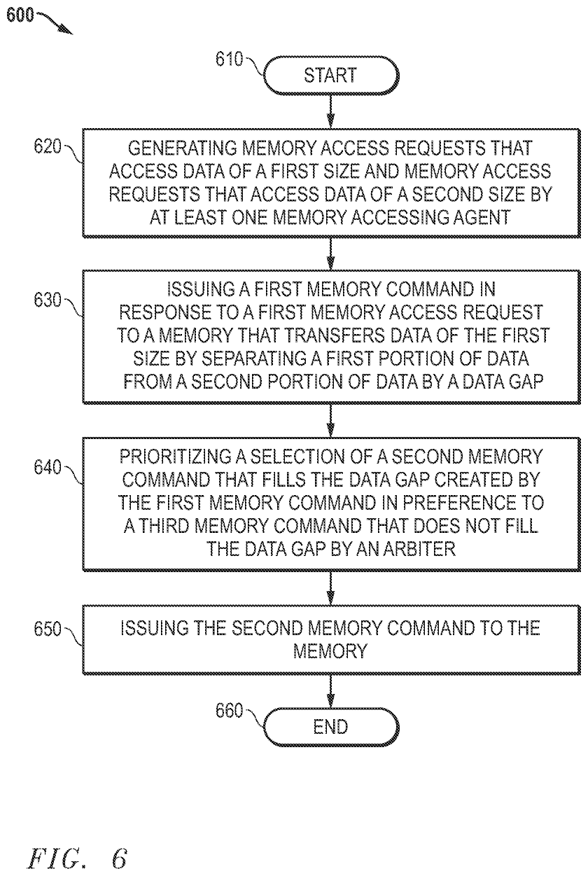

FIG. 6 is a flow chart illustrating a process 600 of performing refresh during a power state change according to some implementations. Process 600 starts in an action box 610.

An action box 620 includes generating memory access requests that access data of a first size and memory access requests that access data of a second size by at least one memory accessing agent. For example, memory access requests that access data of a first size may include CPU cache line fills that are issued by the CPU or by a last-level cache of the CPU. Cache line sizes are typically 64 bytes in length, and in a 16-bit wide system, a cache line fill would require a burst length of 32 to access the whole cache line in a single burst. Memory access requests that access data of a second size may include graphics object accesses that are issued by the GPU or by a last-level cache of the GPU. Graphics objects tend to be 32 bytes in length, and in a 16-bit wide system, would require a burst length of only 16 to access the graphics object in a single burst.

An action box 630 includes issuing a first memory command in response to a first memory access request to a memory that transfers data of the first size by separating a first portion of data from a second portion of data by a data gap. For example, the first memory command could be a 64-byte CPU cache line fill to an LPDDR5 memory that transfers 64 bytes of data in a burst of 32 by separating a first 16-beat portion of the burst length from a second portion 16-beat portion by a data gap. An LPDDR5 memory always creates a data gap for an access with a burst length of 32, but process 600 intelligently fills the data gap using the smart CAS burst continuation feature to increase bandwidth utilization.

An action box 640 includes prioritizing a selection of a second memory command that fills the data gap created by the first memory command in preference to a third memory command that does not fill the data gap by an arbiter. For example, arbiter 238 can prioritize a command that fills a data gap that is a newer command than a command that does not fill the data gap

An action box 650 includes issuing the second memory command to the memory. For example, memory controller 310 uses physical interface circuit 330 to issue memory commands to LPDDR5 memory 350. As should be appreciated, there are many timing requirements that determine whether a particular memory command is eligible to be issued. Memory controller 310 can pick among all timing eligible memory commands using the preference for commands that fill the data gap. Memory controller 310 can also perform actions that make commands that would fill the data gap eligible to be issued earlier, such as precharging a bank so that a later access that would fill a future data gap will have an available comment to an open page. Likewise, there are many precise timing requirements in order for a memory command to “fill the gap”, but memory controller 331 uses burst length history table 235 to locate these so that timing eligible gap-filling commands can be issued at the right time.

Process 600 ends in an action box 660. In a typical memory controller, process 600 is started whenever there is an in-process command selected from command queue 220 that creates a data gap.

While particular implementations have been described, various modifications to these implementations will be apparent to those skilled in the art. For example, the techniques described above can be used advantageously with LPDDR5 DRAM, but can also be used for other memory types that insert a data gap in memory commands. In the illustrated implementation, a first type of command accesses data having a size of 64 bytes/512 bits corresponding to a CPU cache line fill, and a second type of command accesses data having a size of 32 bytes/256 bits corresponding to a graphics access, but these sizes are only exemplary and may vary between embodiments. The exemplary memory controller selectively prioritizes and issues memory accesses that fill the data gap, but the issuance can take into account other arbitration rules such as a preference to continue a current streak or reads or writes, a preference to access open pages, and the like. Moreover, in the illustrated implementation, the precise mechanism used was for an arbiter to prioritize accesses that produce memory commands that fill the data gap in preference to commands that do not fill the data gap, such as the requirement to be to a different bank group than the command that creates the data gap, but other mechanisms to cause the selective issuance of memory commands that do not access data during the timing gap may be used.

Accordingly, it is intended by the appended claims to cover all modifications of the disclosed implementations that fall within the scope of the disclosed implementations.

What is claimed is:

1. A data processing system, comprising:
a data processor for issuing memory commands including a first memory command that accesses data of a first size; and
a memory operative to transfer data of the first size by separating a first portion of data from a second portion of data by a data gap,
wherein the data processor is operable to selectively prioritize and issue a second memory command after issuing the first memory command at a time that fills the data gap.

2. The data processing system of claim 1, wherein the second memory command accesses data of one of the first size and a second size smaller than the first size.

3. The data processing system of claim 1, wherein the data processor comprises a memory controller, and the memory controller comprises:
a command queue for storing a plurality of memory access requests including first memory access requests that access data of the first size and second memory access requests that access data of a second size; and
an arbiter for selecting accesses from the command queue according to a plurality of arbitration rules, wherein the arbiter generates the second memory command for issuance during the data gap.

4. The data processing system of claim 3, wherein the memory controller further comprises:
a burst length history table coupled to the arbiter for storing a history of burst lengths of recently issued memory commands,
wherein the arbiter is further operative to select the second memory command in response to the history of burst lengths.

5. The data processing system of claim 3, wherein the memory controller is further operative to:
issue a third memory command that accesses data at a time following the first memory command such that the memory conducts data of the second memory command during a subsequent data gap.

6. The data processing system of claim 5, wherein the second memory command accesses data of one of the first size and the second size.

7. The data processing system of claim 1, wherein the memory comprises:
a low power double data rate, version five (LPDDR5) memory.

8. A data processor, comprising:
a first memory accessing agent capable of generating a first memory access request of a first size; and
a memory controller comprising:
a command queue for storing a plurality of memory access requests; and
an arbiter for selecting among the plurality of memory access requests stored in the command queue according to a plurality of arbitration rules,
wherein the memory controller is operative to prioritize and issue a first memory command that accesses data of the first size to a memory that is operative to transfer the data of the first size by separating a first portion of data from a second portion of data by a data gap,
wherein the memory controller is further operative to selectively issue a second memory command after issuing the first memory command at a time that fills the data gap.

9. The data processor of claim 8, wherein the second memory command accesses data of one of the first size and a second size smaller than the first size.

10. The data processor of claim 8, wherein the memory controller further comprises:
a burst length history table coupled to the arbiter for storing a history of burst lengths of recently issued memory commands,
wherein the arbiter is further operative to select the second memory command in response to the history of burst lengths.

11. The data processor of claim 8, wherein the memory controller is further operative to:
selectively issue a third memory command that accesses data at a time following an issuance of the first memory command such that the memory conducts data of the third memory command a subsequent the data gap.

12. The data processor of claim 11, wherein the second memory command accesses data of one of the first size and a second size that is smaller than the first size.

13. The data processor of claim 12, further comprising a graphics controller, wherein the memory controller is operative to issue the third memory command in response to a graphics operation provided by the graphics controller.

14. The data processor of claim 8, wherein the first memory accessing agent comprises a central processing unit core complex that is operative to issue the first memory command in response to a cache line fill operation.

15. A method, comprising:
generating a first memory access request that accesses data of a first size by a first memory accessing agent;
issuing a first memory command in response to the first memory access request to a memory that transfers data of the first size by separating a first portion of data from a second portion of data by a data gap; and
selectively prioritizing and issuing a second memory command after issuing the first memory command at a time that fills the data gap.

16. The method of claim 15, wherein selectively prioritizing and issuing the second memory command that does not access data comprises:
selectively prioritizing and issuing a memory command that has one of the first size and a second size smaller than the first size.

17. The method of claim 15, further comprising:
maintaining a history of burst lengths of recently issued memory commands; and
issuing the second memory command that does not access data during the data gap indicated by the history.

18. The method of claim 17, wherein maintaining the history of burst lengths comprises:
storing the history of the burst lengths in a burst length history table.

19. The method of claim 15, further comprising:
storing a first plurality of memory access requests including memory access requests having the first size and a second plurality of memory access requests having a second size in a command queue;
selecting accesses from the command queue according to a plurality of arbitration rules; and
issuing the first memory command to have a first burst length corresponding to the first size, and the second memory command to have a second burst length corresponding to the second size such that data of the second memory command is transferred during the data gap.

20. The method of claim 15, wherein:
generating the first memory access request of the first size to a low power double data rate, version five (LPDDR5) memory.
